(19) United States
(12) Patent Application Publication
(10) Pub. No.: US 2019/0082475 A1
(43) Pub. Date: Mar. 14, 2019

(54) DETERMINING AN ANTENNA FOR SHORT-RANGE COMMUNICATIONS BASED AT LEAST IN PART ON WIRELESS LOCAL AREA NETWORK LINK QUALITY INFORMATION

(71) Applicant: QUALCOMM Incorporated, San Diego, CA (US)

(72) Inventors: Anssi HAVERINEN, San Diego, CA (US); Olaf Josef HIRSCH, Sunnyvale, CA (US); Xiaoxin ZHANG, Sunnyvale, CA (US)

(21) Appl. No.: 15/701,713

(22) Filed: Sep. 12, 2017

(51) Int. Cl. H04W 76/02; H04W 72/08; H04W 4/00; H04B 7/06

(52) U.S. Cl. CPC H04W 76/02; H04W 72/085; H04W 88/06; H04B 7/0608; H04W 4/008

(57) ABSTRACT

In an aspect of the disclosure, a method, a computer-readable medium, and an apparatus are provided. The apparatus may establish a short-range communication link with a second wireless device using a first antenna of a plurality of antennas at the first wireless device. The apparatus may determine WLAN link quality information associated with each of the plurality of antennas. The apparatus may determine which one of the plurality of antennas to use for subsequent short-range communications with the second device based at least in part on the WLAN link quality information. The apparatus may perform subsequent short-range communications with the second device using the one of the plurality of antennas determined based at least in part on the WLAN link quality information.

### BACKGROUND

### Field

The present disclosure relates generally to communication systems, and more particularly, to determining an antenna for short-range communications based at least in part on wireless local area network (WLAN) link quality information.

### Background

A wireless personal area network (WPAN) is a personal, short-range area wireless network for interconnecting devices centered around a specific distance from a user. WPANs have gained popularity because of the flexibility and convenience in connectivity that WPANs provide. WPANs, such as WPAN's based on short-range communication technology (e.g., a Bluetooth® (BT) protocol, a Zigbee® protocol, etc.), provide wireless connectivity to peripheral devices by providing short-range wireless links that allow connectivity within a specific distance (e.g., 5 meters, 10 meter, 20 meters, 100 meters, etc.). In contrast to WPAN systems, WLANs provide connectivity to devices that are located within a larger geographical area, such as the area covered by a building or a campus, for example. WLANs are typically based on a IEEE 802.11 protocol (e.g., Wi-Fi protocol), typically operate within a 100-meter or greater than 100-meter range, and are generally utilized to supplement the communication capacity provided by traditional wired local area networks (LANs) installed in the same geographic area as the WLAN. In some instances, WLANs may operate in conjunction with WPANs to provide users with an enhanced overall functionality.

A wireless device thus may have multiple radio interfaces that support multiple radio access technologies (RATs) as defined by various wireless communication protocols (e.g., Wi-Fi, BT, etc.). Accordingly, a wireless device may need to concurrently operate multiple radio interfaces corresponding to multiple RATs (e.g., Wi-Fi, BT, etc.). For small handheld wireless devices, such as user equipments (UEs), shared antennas for different RATs is common. When communicating using a short-range protocol, a wireless device may switch between antennas because a user's handgrip may cause different antennas to have significantly different link qualities (e.g., received signal strength indicator (RSSI), signal-to-interference-plus-noise ratio (SINR), error vector magnitude (EVM), etc.). Switching to an antenna with an increased link quality may improve short-range communications at the wireless device in that fewer transmissions may be dropped. However, a typical short-range transceiver may have a single transmitter and a single receiver. Hence, a short-range transceiver at the wireless device may not be able to monitor the link quality on two or more antennas at the same time. Consequently, the short-range transceiver may switch to each antenna to obtain short-range link quality measurements prior to determining which antenna to use for subsequent short-range communications. Switching to each antenna to obtain short-range link quality measurements prior to determining which antenna to use for subsequent short-range communications may not be optimal in terms of device performance.

Thus, there is a need to provide concurrent link quality information associated with a plurality of different antennas to a short-range transceiver at a wireless device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A wireless device may have multiple radio interfaces that support multiple RATs as defined by various wireless communication protocols (e.g., Wi-Fi, BT, etc.). Accordingly, a wireless device may need to concurrently operate multiple radio interfaces corresponding to multiple RATs (e.g., Wi-Fi, BT, etc.). For small handheld wireless devices, such as UEs, shared antennas for different RATs is common. When communicating using a short-range protocol, a wireless device may switch between antennas because a user's handgrip may cause different antennas to have different link qualities (e.g., received signal strength indicator (RSSI), signal-to-interference-plus-noise ratio (SINR), error vector magnitude (EVM), etc.). Switching to an antenna with an increased link quality may improve short-range communications at the wireless device in that fewer transmissions may be dropped. However, a typical short-range transceiver may have a single transmitter and a single receiver. Hence, a short-range transceiver at the wireless device may not be able to monitor the link quality on two or more antennas at the same time. Consequently, the short-range transceiver may switch to each antenna to obtain short-range link quality measurements prior to determining which antenna to use for subsequent short-range communications. Switching to each antenna to obtain short-range link quality measurements prior to determining which antenna to use for subsequent short-range communications may not be optimal in terms of device performance.

Thus, there is a need to provide concurrent link quality information associated with a plurality of different antennas to a short-range transceiver at a wireless device.

In an aspect of the disclosure, a method, a computer-readable medium, and an apparatus are provided. The apparatus may establish a short-range communication link with a second wireless device using a first antenna of a plurality of antennas at the first wireless device. The apparatus may determine WLAN link quality information associated with each of the plurality of antennas. The apparatus may determine which one of the plurality of antennas to use for subsequent short-range communications with the second device based at least in part on the WLAN link quality information. The apparatus may perform subsequent short-range communications with the second device using the one of the plurality of antennas determined based at least in part on the WLAN link quality information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a WPAN and WLAN.

FIG. 2 is block diagram of a multiple RAT device in accordance with certain aspects of the disclosure.

FIGS. 3A and 3B are a diagram illustrating technique(s) for determining an antenna for short-range communications based at least in part on WLAN link quality information in accordance with certain aspects of the disclosure.

FIGS. 4A-4D are a flowchart of a method of wireless communication.

FIG. 5 is a conceptual data flow diagram illustrating the data flow between different means/components in an exemplary apparatus.

FIG. 6 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

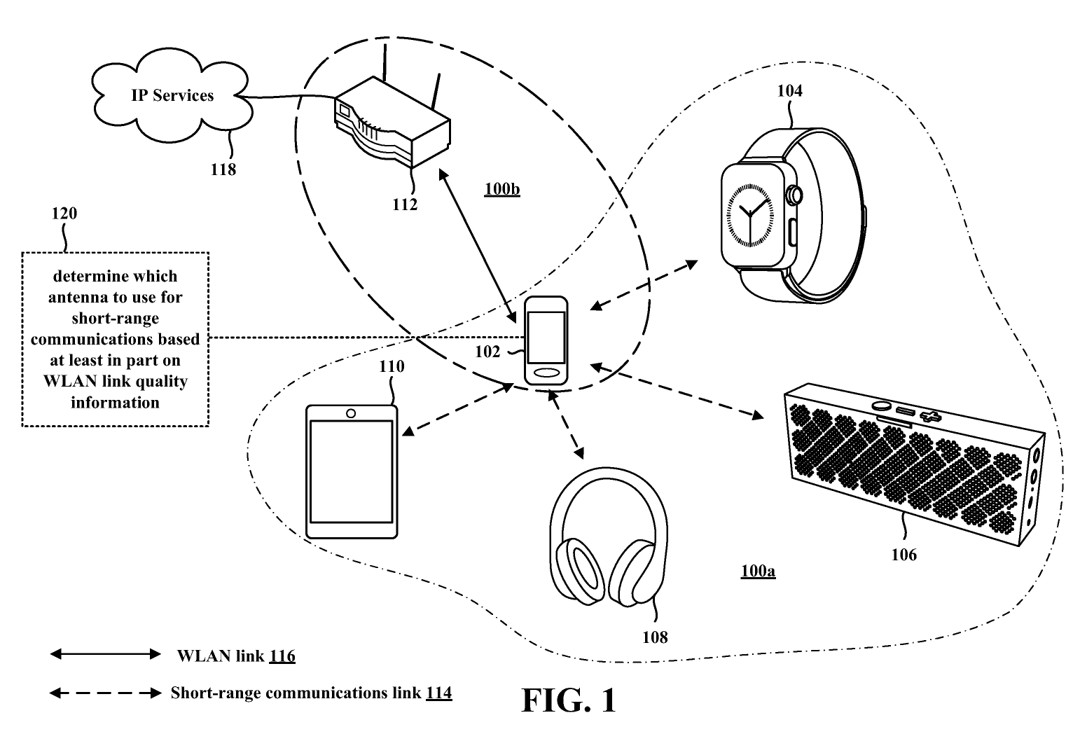

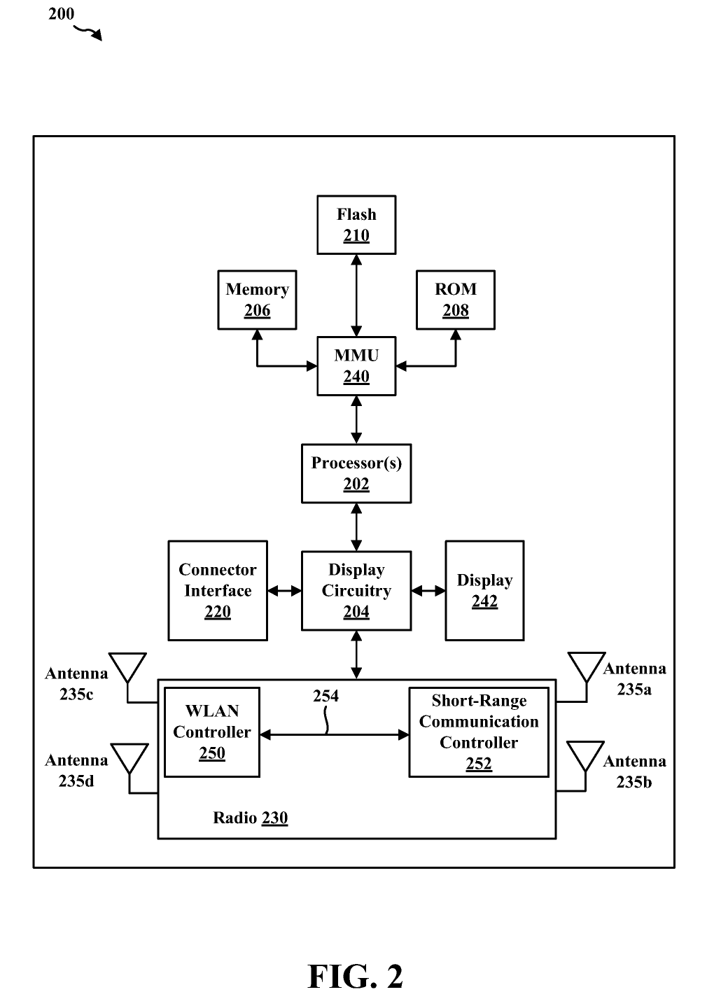

FIG. 1 illustrates an example WPAN 100a and a WLAN 100b in accordance with certain aspects of the disclosure. A first device 102 may be part of both the WPAN 100a and the WLAN 100b, and thus be configured to operate multiple radio interfaces corresponding to multiple RATs (e.g., Wi-Fi, BT, etc.) concurrently. For example, a BT radio interface at the first device 102 may be used for communications within the WPAN 100a, and a Wi-Fi interface at the first device 102 may be used for communications within the WLAN 100b. Shared antennas for different RATs may be used by the first device 102, e.g., as discussed below with reference to FIGS. 2, 3A, 3B, 4A-4D, 5, and 6. The shared antennas may be used for, e.g., short-range communications via a short-range communication link 114 and Wi-Fi communications via a WLAN link 116. In certain aspects, the short-range communications and Wi-Fi communications may be performed using the same frequency band (e.g., 2.4-2.4835 GHz frequency range, 5 GHz frequency range, etc.). In certain other aspects, the short-range communications and Wi-Fi communications may be performed using different frequency bands.

Examples of the first device 102 include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similarly functioning device.

Within the WPAN 100a, the first device 102 may communicate with one or more second devices 104, 106, 108, 110 (e.g., peripheral devices) using a short-range communications protocol (e.g., BT protocol, Zigbee® protocol, etc.). Examples of the one or more second devices 104, 106, 108, 110 include a cellular phone, a smart phone, a SIP phone, a mobile station (STA), a laptop, a PC, a desktop computer, a PDA, a satellite radio, a global positioning system, a multimedia device, a video device, a digital audio player (e.g., MP3 player), a camera, a game console, a tablet, a smart device, a wearable device such as a smart watch or wireless headphones, a vehicle, an electric meter, a gas pump, a toaster, or any other similarly functioning device. Although the first device 102 is illustrated in communication with four second devices 104, 106, 108, 110 in the WPAN 100a, the first device 102 may communicate with more or fewer than four devices within the WPAN 100a without departing from the scope of the present disclosure.

Within the WLAN 100b, the first device 102 may communicate with at least one third device 112 using a Wi-Fi communications protocol (e.g., IEEE 802.11 protocol, etc.). The third device 112 may be configured to connect to Internet Protocol (IP) Services 118. The IP Services 118 may include the Internet, an intranet, an IP Multimedia Subsystem (IMS), a PS Streaming Service, and/or other IP services. The third device 112 may communicate information between the first device 102 and IP Services 118. Examples of the third device 112 include a Wi-Fi router and/or a Wi-Fi AP. Wi-Fi communications may be performed using a 5 GHz unlicensed spectrum. When communicating in an unlicensed frequency spectrum, the first device 102 and/or the third device 112 may perform a clear channel assessment (CCA) prior to communicating with one another in order to determine whether the channel is available.

Referring again to FIG. 1, in certain aspects, the first device 102 may be configured to determine which antenna to use for short-range communications based at least in part on WLAN link quality information (120).

FIG. 2 is block diagram of a multiple RAT device 200 in accordance with certain aspects of the disclosure. The multiple RAT device 200 may correspond to, e.g., the first device 102, 302, the apparatus 502/502′.

As shown in FIG. 2, the device 200 may include a processing element, such as processor(s) 202, which may execute program instructions for the device 200. The device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the received addresses to locations in memory (e.g., memory 206, ROM 208, Flash memory 210) and/or to other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor 202 may be coupled to various other circuits of the device 200. For example, the device 200 may include various types of memory, a connector interface 220 (e.g., for coupling to the computer system), the display 242, and wireless communication circuitry (e.g., for Wi-Fi, BT, etc.). The device 200 may include a plurality of antennas 235a, 235b, 235c, 235d, for performing wireless communication with Wi-Fi access points/routers (e.g., see 112 in FIG. 1) and/or short-range communications enabled devices (e.g., see 104, 106, 108, 110 in FIG. 1).

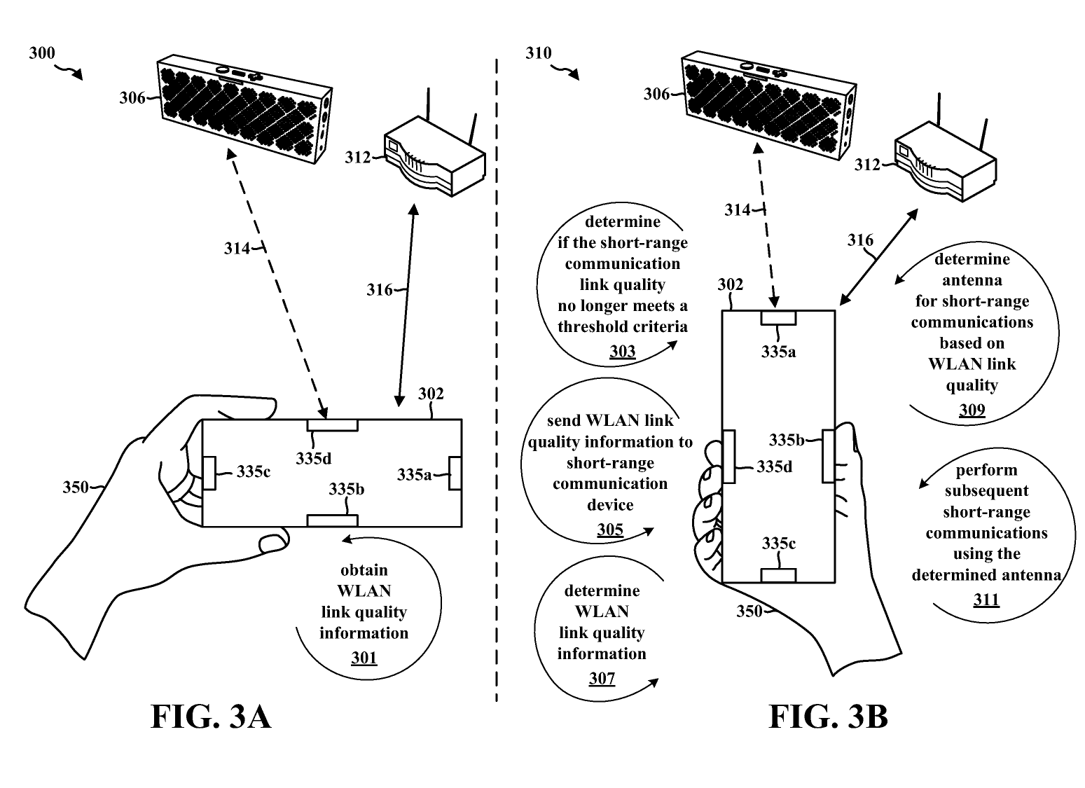

In certain aspects, the device 200 may include hardware and software components (a processing element) configured to determine which antenna 235a, 235b, 235c, 235d to use for short-range communications based at least in part on the WLAN link quality information. For example, the device 200 may store and execute a WLAN software driver for controlling WLAN operations. The device 200 may also include short-range communications firmware or other hardware/software for controlling short-range communications operations. The device 200 may be configured to implement part or all of the techniques described below with reference to FIGS. 3A, 3B, 4, 5, and 6, e.g., by executing program instructions stored on a memory medium (e.g., a non-transitory computer-readable memory medium) and/or through hardware or firmware operation. In other embodiments, the techniques described below with reference to FIGS. 3A, 3B, 4, 5, and 6 may be at least partially implemented by a programmable hardware element, such as an field programmable gate array (FPGA), and/or as an application specific integrated circuit (ASIC).

In certain aspects, radio 230 may include separate controllers configured to control communications for various respective RAT protocols. For example, as shown in FIG. 2, radio 230 may include a WLAN controller 250 configured to control WLAN communications and a short-range communications controller 252 configured to control short-range communications. In some aspects, one or more of the WLAN controller 250 and/or the short-range communications controller 252 may be implemented as hardware, software, firmware or some combination thereof

In certain aspects, the WLAN controller 250 may be configured to communicate with a second device using a WLAN link (e.g., see 116 in FIG. 1) using all of the antennas 235a, 235b, 235c, 235d. In certain other aspects, the WLAN controller 250 may be configured to obtain WLAN link quality information associated with each of the antennas 235a, 235b, 235c, 235d. The WLAN link quality information may be sent from the WLAN controller 250 to the short-range communications controller 252 via a coexistence interface 254 (e.g., a wired interface or a wireless interface). In certain aspects, the coexistence interface 254 may include a BT-WiFi coexistence interface. The short-range communications controller 252 may be configured communicate with a second device (e.g., see 104, 106, 108, 110 in FIG. 1) using a short-range communication link (e.g., 114 in FIG. 1) and a single antenna. The short-range communications controller 252 may be configured to determine which antenna 235a, 235b, 235c, 235d to use for short-range communications based at least in part on the WLAN link quality information sent via the coexistence interface 254 from the WLAN controller 250 to the short-range communications controller 252.

A wireless device may have multiple radio interfaces that support multiple RATs as defined by various wireless communication protocols (e.g., Wi-Fi, BT, etc.). Accordingly, a wireless device may need to concurrently operate multiple radio interfaces corresponding to multiple RATs (e.g., Wi-Fi, BT, etc.). For small handheld wireless devices, such as UEs, shared antennas for different RATs is common. When communicating using a short-range protocol, a wireless device may switch between antennas because a user's handgrip may cause different antennas to have different link qualities (e.g., received signal strength indicator (RSSI), signal-to-interference-plus-noise ratio (SINR), error vector magnitude (EVM), etc.). Switching to an antenna with an increased link quality may improve short-range communications at the wireless device in that fewer transmissions may be dropped. However, a typical short-range transceiver may have a single transmitter and a single receiver. Hence, a short-range transceiver at the wireless device may not be able to monitor the link quality on two or more antennas at the same time. Consequently, the short-range transceiver may switch to each antenna to obtain short-range link quality measurements prior to determining which antenna to use for subsequent short-range communications. Switching to each antenna to obtain short-range link quality measurements prior to determining which antenna to use for subsequent short-range communications may increase the time needed to determine which antenna to use for short-range communications, and hence, reduce the quality of the short-range communications.

There is a need to provide concurrent link quality information associated with a plurality of different antennas to a short-range transceiver at a wireless device.

FIGS. 3A and 3B are a diagram 300, 310, respectively, illustrating technique(s) for determining an antenna for short-range communications based at least in part on WLAN link quality information in accordance with certain aspects of the disclosure. The technique may be performed by, e.g., a first device 302 that establishes a short-range communication link 314 with a second device 306, and that establishes a WLAN link 316 with a third device 312.

In certain aspects, the first device 302 and the second device 306 may communicate using a short-range communications protocol (e.g., BT protocol, Zigbee® protocol, etc.). The first device 302 may use, e.g., a single antenna (e.g., one of first antenna 335a, second antenna 335b, third antenna 335c, or fourth antenna 335d) when communicating with the second device 306 via the short-range communication link 314. In certain other aspects, the first device 302 and the third device 312 may communicate using the IEEE 802.11 protocol (e.g., Wi-Fi protocol). The first device 302 may use, e.g., all antennas (e.g., first antenna 335a, second antenna 335b, third antenna 335c, and fourth antenna 335d) when communicating with the third device 312 via the WLAN communication link 316.

The first device 302 may correspond to, e.g., first device 102, the device 200, the apparatus 502/502′. The second device 306 may correspond to, e.g., second device 104, 106, 108, 110, 550. The third device 312 may correspond to, e.g., third device 112, 555.

Referring to FIG. 3A, the first device 302 may be held by a user 350 in a first orientation. Based at least in part on the first orientation, the first device 302 may determine which of the first antenna 335a, the second antenna 335b, the third antenna 335c, or the fourth antenna 335d has a highest link quality associated therewith. Examples of link quality include, but are not limited to, e.g., RSSI, SINR, and/or EVM, or any other information that may be used to determine link quality.

In the particular example illustrated in FIG. 3A, the user's 350 hand obscures the third antenna 335c, and hence, the first device 302 may determine that the third antenna 335c has the lowest short-range communication link quality. In the example illustrated in FIG. 3A, the first device 302 may determine that the fourth antenna 335d has the highest short-range communication link quality. Thus, the first device 302 may select the fourth antenna 335d to perform short-range communications (e.g., via the short-range communication link 314) with the second device 306 in FIG. 3A.

Because a single antenna at the first device 302 is used for short-range communications, short-range link quality information associated with the first antenna 335a, the second antenna 335b, and the third antenna 335c may not be obtained by the short-range radio while the fourth antenna 335d is used for short-range communications.

Still referring to FIG. 3A, the first device 302 may establish a WLAN communication link 316 with the third device 312. In certain configurations, the first device 302 may use the first antenna 335a, the second antenna 335b, the third antenna 335c, and the fourth antenna 335d to perform WLAN communications with the third device 312. In certain aspects, the first device 302 may obtain (at 301) WLAN link quality information (e.g., RSSI, SINR, EVM, etc.) associated with the WLAN link 316 and each of the first antenna 335a, the second antenna 335b, the third antenna 335c, and the fourth antenna 335d. The WLAN link quality information may be obtained using one or more RX chains associated with the first antenna 335a, the second antenna 335b, the third antenna 335c, and the fourth antenna 335d.

The WLAN link quality information may be obtained (at 301) using a WLAN device (e.g., see WLAN controller 250 in FIG. 2) at the first device 302. In certain aspects, the WLAN link quality information may be sent (at 305) from the WLAN device at the first device 302 to a short-range communication device (e.g., short-range communications controller 252 in FIG. 2) at the first device 302 via a coexistence interface (e.g., coexistence interface 254 in FIG. 2).

Referring to FIG. 3B, the user 350 may change the orientation of the first device 302 to a second orientation. In certain aspects, the first device 302 may determine (at 303) if the short-range communication link quality associated with the fourth antenna 335d satisfies a first threshold criteria within a predetermined time period (e.g., 5 ms, 10 ms, 1 s, 1 minute, 5 minutes, 1 hour, etc.). The first device 302 may determine (at 303) if the short-range communication link quality associated with the fourth antenna 335d no longer meets a first threshold at predetermined intervals. The predetermined intervals may be shorter than the predetermined time period). For example, the first threshold criteria may include having an RSSI that is greater than or equal to a predetermined value (e.g., −80 dBm).

As illustrated in FIG. 3B, the user's 350 hand may obscure the second antenna 335b, the third antenna 335c, and the fourth antenna 335d in the second orientation. In certain configurations, the short-range link quality associated with the fourth antenna 335d in the second orientation may still meet a first threshold criteria when the first device 302 is held in the second orientation. In certain other configurations, the short-range link quality associated with the fourth antenna 335d may no longer meet the first threshold criteria when the first device 302 is held in the second orientation, e.g., due to signal attenuation caused by the user's 350 hand.

In certain aspects, the first device 302 may determine (at 307) the WLAN link quality information associated with each of the plurality of antennas. For example, the WLAN link quality information may be determined based on the information sent (at 303) from the WLAN device to the short-range communication device via the coexistence interface.

Still referring to FIG. 3B, the first device 302 may determine (at 309) which antenna (e.g., from a plurality of antennas) to use for subsequent short-range communications with the second device 306 based at least in part on the WLAN link quality information

### First Configuration

In a first configuration, when the first device 302 determines (at 303) that the short-range communication link quality associated with the fourth antenna 335d no longer meets the first threshold criteria (e.g., when the RSSI drops below −80 dBm) within the predetermined time period, the first device 302 may determine (at 309) which of the plurality of antennas (e.g., 335a, 335b, 335c, 335d) to use for subsequent short-range communications with the second device 306 based at least in part on the WLAN link quality information (e.g., if the WLAN link quality information is available).

In the first configuration, the first device 302 may determine (at 309) which of the plurality of antennas (e.g., 335a, 335b, 335c, 335d) to use for subsequent short-range communications by determining, based on the WLAN link quality information, a highest WLAN link quality antenna of the plurality of antennas (e.g., 335a, 335b, 335c, 335d).

With reference to FIG. 3B, assume that the RSSI associated with the first antenna 335a is −70 dBm, the RSSI associated with the second antenna 335b is −76 dBm, the RSSI associated with the third antenna 335c is −81 dBm, and the RSSI associated with the fourth antenna 335d is −85 dBm. Based on the RSSI values of −70 dBm, −76 dBm, −81 dBm, and −85 dBm, the first device 302 may determine that the first antenna 335a has the highest WLAN link quality (e.g., −70 dBm).

The first device 302 may further determine (at 309) which of the plurality of antennas (e.g., 335a, 335b, 335c, 335d) to use for subsequent short-range communications by determining if a WLAN link quality associated with the highest WLAN link quality antenna meets a second threshold criteria. For example, assume that meeting the second threshold criteria includes having an RSSI that is greater than or equal to −75 dBm. Here, because the WLAN link quality associated with the first antenna 335a is greater than or equal to the second threshold criteria (e.g., −70 dBm>−75 dBm), the first device 302 may perform (at 311) subsequent short-range communications with the second device 306 using the first antenna 335a (e.g., the highest WLAN link quality antenna).

Alternatively, in an example not illustrated in FIG. 3B, assume that meeting the second threshold criteria includes having an RSSI that is greater than or equal to −65 dBm, and that the highest WLAN link quality antenna is the first antenna 335a. For example, assume the first antenna 335a has an RSSI of −70 dBm. Here, because the WLAN link quality associated with the first antenna 335a is less than the second threshold criteria (e.g., −70 dBm<−65 dBm), the first device 302 may determine not to switch to the first antenna 335a. Instead, the first device 302 may perform (at 311) subsequent short-range communications with the second device 306 using the fourth antenna 335d.

### Second Configuration

In a second configuration, when the predetermined time period expires without the short-range link quality of the fourth antenna 335d dropping below the first threshold criteria, the first device 302 may determine (at 309) which of the plurality of antennas (e.g., 335a, 335b, 335c, 335d) to use for subsequent short-range communications with the second device 306 based at least in part on the WLAN link quality information (e.g., when the WLAN link quality information is available).

In the second configuration, the first device 302 may determine (at 309) which of the plurality of antennas (e.g., 335a, 335b, 335c, 335d) to use for subsequent short-range communications by determining a highest WLAN link quality antenna based on the WLAN link quality information.

With respect to the example illustrated in FIG. 3B, assume that the RSSI associated with the first antenna 335a is −35 dBm, the RSSI associated with the second antenna 335b is −46 dBm, the RSSI associated with the third antenna 335c is −57 dBm, and the RSSI associated with the fourth antenna 335d is −70 dBm. Based on the RSSI values of −35 dBm, −46 dBm, −57 dBm, and −70 dBm, the first device 302 may determine that the first antenna 335a has the highest WLAN link quality.

The first device 302 may further determine (at 309) which of the plurality of antennas (e.g., 335a, 335b, 335c, 335d) to use for subsequent short-range communications by determining if a WLAN link quality associated with the highest WLAN link quality antenna meets a third threshold criteria. For example, assume that meeting the third threshold criteria includes having an RSSI that is greater than or equal to −40 dBm. Here, because the WLAN link quality associated with the first antenna 335a is greater than or equal to the third threshold criteria (e.g., −35 dBm>−40 dBm), the first device 302 may perform (at 311) subsequent short-range communications with the second device 306 using the first antenna 335a (e.g., the highest WLAN link quality antenna).

Alternatively, in an example not illustrated in FIG. 3B, assume that meeting the third threshold criteria includes having an RSSI that is great than or equal to −25 dBm, and that the highest WLAN link quality antenna is the first antenna 335a. For example, assume the first antenna 335a has an RSSI of −35 dBm. Here, because the WLAN link quality associated with the first antenna 335a is less than the third threshold criteria (e.g., −35 dBm<−25 dBm), the first device 302 may determine not to switch to the first antenna 335a. Instead, the first device 302 may perform (at 311) subsequent short-range communications with the second device 306 using the fourth antenna 335d.

### Third Configuration

In a third configuration, assume that the WLAN link quality information is not available at the first device 302. Here, the first device 302 may determine (at 309) which of the plurality of antennas (e.g., 335a, 335b, 335c, 335d) to use for subsequent short-range communications with the second device 306 by switching between each of the plurality of antennas to determine a short-range communication link quality associated with each antenna.

The first device 302 may use the highest short-range communication link quality antenna for subsequent short-range communications with the second device 306. For example, assume that the RSSI associated with the first antenna 335a is −35 dBm, the RSSI associated with the second antenna 335b is −46 dBm, the RSSI associated with the third antenna 335c is −57 dBm, and the RSSI associated with the fourth antenna 335d is −70 dBm. Based on the RSSI values of −35 dBm, −46 dBm, −57 dBm, and −70 dBm, the first device 302 may perform (at 311) subsequent short-range communications with the second device 306 using the first antenna 335a (e.g., highest short-range communications link quality antenna).

Using the techniques described above, the first device 302 may be able to leverage WLAN link quality information in order to determine an antenna for subsequent short-range communications without switching to each antenna to measure an associated short-range link quality. Hence, the first device 302 may use less battery power and may drop fewer short-range communications than a device that does not leverage WLAN link quality information to determine an antenna for subsequent short-range communications.

In FIGS. 3A and 3B, although the first device 302 is depicted in different orientations, the techniques described above with FIGS. 3A and 3B may be implemented by the first device 302 without a change in orientation.

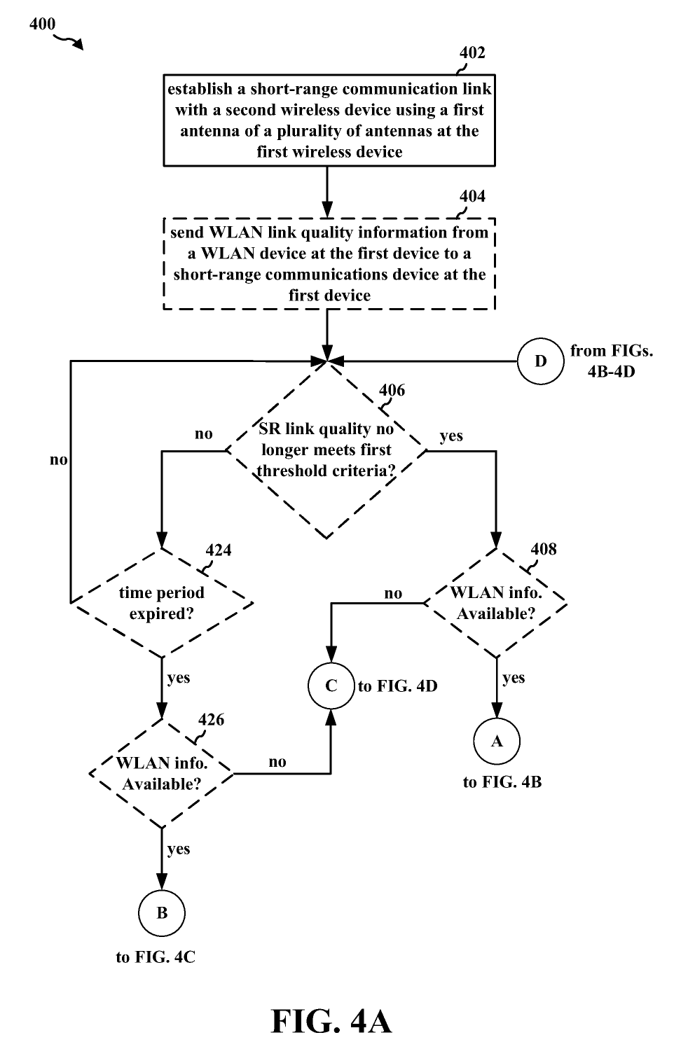

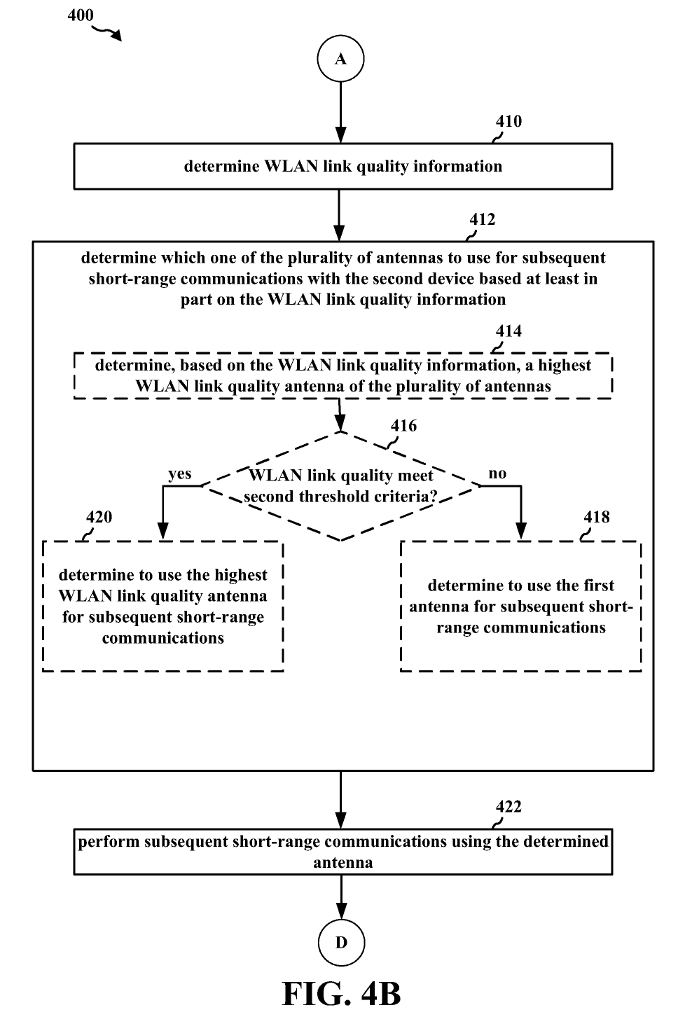

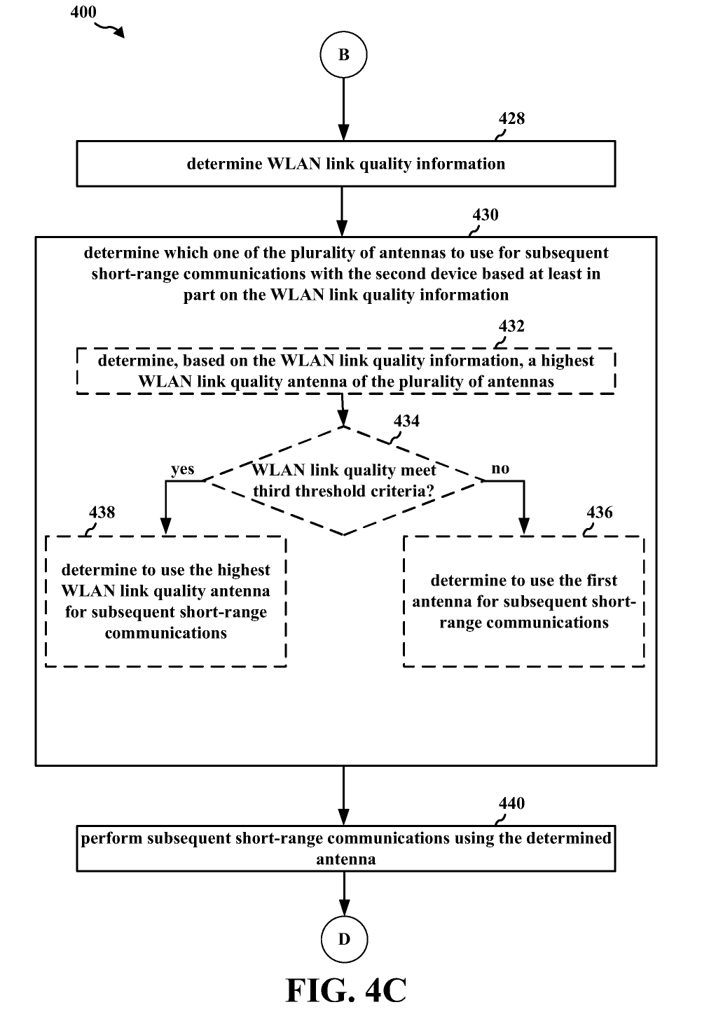

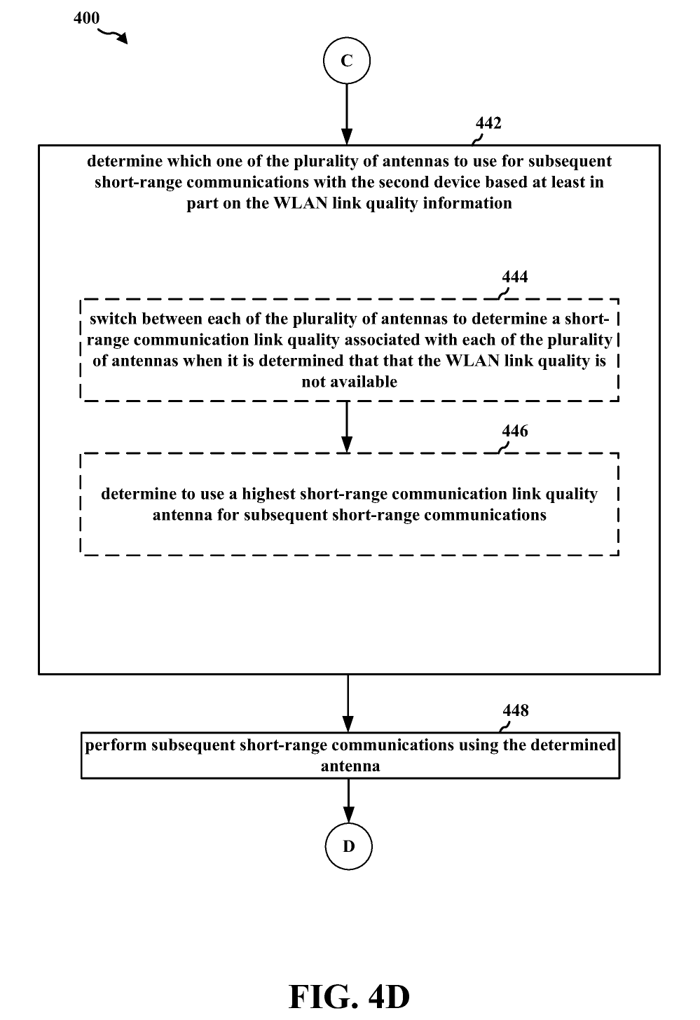

FIGS. 4A-4D are a flowchart 400 of a method of wireless communication. The method may be performed by a first device (e.g., the first device 102, 302, device 200, the apparatus 502/502′) in communication with a second device (e.g., the second device 104, 106, 108, 110, 306, 550) and a third device (e.g., the third device 112, 312, 555). In FIGS. 4A-4D, optional operations are indicated with dashed lines.

Referring to FIG. 4A, at 402, the first device may establish a short-range communication link with a second wireless device using a first antenna of a plurality of antennas at the first wireless device. For example, referring to FIG. 3A, the first device 302 may establish a short-range communication link 314 with a second device 306 using a short-range pairing procedure.

At 404, the first device may send WLAN link quality information from a WLAN device at the first device to a short-range communication device at the first device via a coexistence interface. In certain aspects, the WLAN link quality information may include at least one of RSSI, SINR, or EVM. For example, referring to FIG. 3B, the WLAN link quality information may be sent (at 305) from the WLAN device at the first device 302 to a short-range communication device (e.g., short-range communications controller 252 in FIG. 2) at the first device 302 via a coexistence interface (e.g., coexistence interface 254 in FIG. 2).

At 406, the first device may determine if a short-range communication link quality associated with the first antenna no longer meets a first threshold criteria within a predetermined time period. For example, referring to FIG. 3B, the first device 302 may determine (at 303) if the short-range communication link quality associated with the fourth antenna 335d no longer meets a first threshold criteria within a predetermined time period (e.g., 5 ms, 10 ms, 1 s, 1 minute, 5 minutes, 1 hour, etc.). The first device 302 may determine (at 303) if the short-range communication link quality associated with the fourth antenna 335d no longer meets a first threshold at predetermined intervals. The predetermined intervals may be shorter than the predetermined time period). For example, the first threshold criteria may include having an RSSI that is greater than or equal to a predetermined value (e.g., −80 dBm).

At 408, if the first device determines (at 406) that the short-range communication link quality associated with the first antenna no longer meets the first threshold criteria within a predetermined time period, the first device may determine if WLAN link quality information is available. For example, referring to FIG. 3B, the first device 302 may determine if the WLAN link quality information is available before determining which antenna to use for subsequent short-range communications with the second device 306.

Referring to FIG. 4B, at 410, if the first device determines (at 408) that the

WLAN link quality information is available, the first device may determine the WLAN link quality information associated with each of the plurality of antennas. For example, referring to FIG. 3A, the first device 302 may determine (at 307) the WLAN link quality information associated with each of the plurality of antennas. For example, the WLAN link quality information may be determined based on the information sent (at 303) from the WLAN device to the short-range communication device via the coexistence interface.

At 412, the first device may determine which one of the plurality of antennas to use for subsequent short-range communications with the second device based at least in part on the WLAN link quality information. For example, referring to FIG. 3B, the first device 302 may determine (at 309) which antenna (e.g., from a plurality of antennas) to use for subsequent short-range communications with the second device 306 based at least in part on the WLAN link quality information.

At 414, the first device may determine, based on the WLAN link quality information, a highest WLAN link quality antenna of the plurality of antennas. For example, referring to FIG. 3B, assume that the RSSI associated with the first antenna 335a is −70 dBm, the RSSI associated with the second antenna 335b is −76 dBm, the RSSI associated with the third antenna 335c is −81 dBm, and the RSSI associated with the fourth antenna 335d is −85 dBm. Based on the RSSI values of −70 dBm, −76 dBm, −81 dBm, and −85 dBm, the first device 302 may determine that the first antenna 335a has the highest WLAN link quality (e.g., −70 dBm).

At 416, the first device may determine if a WLAN link quality associated with the highest WLAN link quality antenna meets a second threshold criteria. For example, referring to FIG. 3B, the first device 302 may further determine (at 309) which of the plurality of antennas (e.g., 335a, 335b, 335c, 335d) to use for subsequent short-range communications by determining if a WLAN link quality associated with the highest WLAN link quality antenna meets a second threshold criteria.

At 418, the first device may determine to use the first antenna for subsequent short-range communications when it is determined (at 416) that the WLAN link quality associated with the highest WLAN link quality antenna does not meet the second threshold criteria. For example, referring to FIG. 3B, assume that meeting the second threshold criteria includes having an RSSI that is greater than or equal to −65 dBm, and that the highest WLAN link quality antenna is the first antenna 335a. For example, assume the first antenna 335a has an RSSI of −70 dBm. Here, because the WLAN link quality associated with the first antenna 335a is less than the second threshold criteria (e.g., −70 dBm<−65 dBm), the first device 302 may determine not to switch to the first antenna 335a. Instead, the first device 302 may perform (at 311) subsequent short-range communications with the second device 306 using the fourth antenna 335d.

At 420, the first device may determine to use the highest WLAN link quality antenna for subsequent short-range communications when it is determined (at 416) that the WLAN link quality associated with the highest WLAN link quality antenna meets the second threshold criteria. For example, referring to FIG. 3B, the first device 302 may further determine (at 309) which of the plurality of antennas (e.g., 335a, 335b, 335c, 335d) to use for subsequent short-range communications by determining if a WLAN link quality associated with the highest WLAN link quality antenna meets a second threshold criteria. For example, assume that meeting the second threshold criteria includes having an RSSI that is greater than or equal to −75 dBm, and that the first antenna 335a is the highest WLAN link quality antenna with an RSSI of −70 dBm. Here, because the WLAN link quality associated with the first antenna 335a is greater than or equal to the second threshold criteria (e.g., −70 dBm>−75 dBm), the first device 302 may perform (at 311) subsequent short-range communications with the second device 306 using the first antenna 335a (e.g., the highest WLAN link quality antenna).

At 422, the first device may perform subsequent short-range communications using the determined antenna. For example, referring to FIG. 3B, the first device 302 may perform (at 311) subsequent short-range communications with the second device 306 using the first antenna 335a (e.g., the highest WLAN link quality antenna) or the fourth antenna 335d based on the outcome of 416.

Once the first device determines (at 410, 412, 414, 416, 418, 420, 422) which one of the plurality of antennas to use for subsequent short-range communications with the second device based at least in part on the WLAN link quality information, the method may return to 406.

Referring to FIG. 4A, at 424, if the first device determines (at 406) that the short-range communication link quality associated with the first antenna meets the first threshold criteria, the first device may determine if the predetermined time period expires. For example, referring to FIG. 3B, the first device 302 may determine if the predetermined time period expires without the short-range link quality of the fourth antenna 335d dropping below the first threshold criteria.

If, the first device determines (at 422) that the predetermined time period is not expired, the method may return to 406.

At 426, when the first device determines (at 422) that the predetermined time period expires without the short-range link quality of the fourth antenna 335d dropping below the first threshold criteria, the first device may determine if the WLAN link quality information is available. For example, referring to FIG. 3B, the first device 302 may determine if the WLAN link quality information is available before determining which antenna to use for subsequent short-range communications with the second device 306.

Referring to FIG. 4C, at 428, the first device may determine the WLAN link quality information associated with each of the plurality of antennas. For example, referring to FIG. 3A, the first device 302 may determine (at 307) the WLAN link quality information associated with each of the plurality of antennas. For example, the WLAN link quality information may be determined based on the information sent (at 303) from the WLAN device to the short-range communication device via the coexistence interface.

At 430, the first device may determine which one of the plurality of antennas to use for subsequent short-range communications with the second device based at least in part on the WLAN link quality information. For example, referring to FIG. 3B, the first device 302 may determine (at 309) which of the plurality of antennas (e.g., 335a, 335b, 335c, 335d) to use for subsequent short-range communications with the second device 306 based at least in part on the WLAN link quality information (e.g., if the WLAN link quality information is available).

At 432, the first device may determine, based on the WLAN link quality information, a highest WLAN link quality antenna of the plurality of antennas. For example, referring to FIG. 3B, assume that the RSSI associated with the first antenna 335a is −70 dBm, the RSSI associated with the second antenna 335b is −76 dBm, the RSSI associated with the third antenna 335c is −81 dBm, and the RSSI associated with the fourth antenna 335d is −85 dBm. Based on the RSSI values of −70 dBm, −76 dBm, −81 dBm, and −85 dBm, the first device 302 may determine that the first antenna 335a has the highest WLAN link quality (e.g., −70 dBm).

At 434, the first device may determine if the WLAN link quality associated with the highest WLAN link quality antenna meets a third threshold criteria. For example, referring to FIG. 3B, the first device 302 may further determine (at 309) which of the plurality of antennas (e.g., 335a, 335b, 335c, 335d) to use for subsequent short-range communications by determining if a WLAN link quality associated with the highest WLAN link quality antenna meets a third threshold criteria.

At 436, the first device may determine to use the first antenna for subsequent short-range communications when it is determined that the WLAN link quality associated with the highest WLAN link quality antenna does not meet the third threshold criteria. For example, referring to FIG. 3B, assume that meeting the third threshold criteria includes having an RSSI that is great than or equal to −25 dBm, and that the highest WLAN link quality antenna is the first antenna 335a. For example, assume the first antenna 335a has an RSSI of −35 dBm. Here, because the WLAN link quality associated with the first antenna 335a is less than the third threshold criteria (e.g., −35 dBm<−25 dBm), the first device 302 may determine not to switch to the first antenna 335a. Instead, the first device 302 may perform (at 311) subsequent short-range communications with the second device 306 using the fourth antenna 335d.

At 438, the first device may determine to use the highest WLAN link quality antenna for subsequent short-range communications when it is determined that the WLAN link quality associated with the highest WLAN link quality antenna meets the third threshold criteria. For example, referring to FIG. 3B, assume that meeting the third threshold criteria includes having an RSSI that is greater than or equal to −40 dBm. Here, because the WLAN link quality associated with the first antenna 335a is greater than or equal to the third threshold criteria (e.g., −35 dBm>−40 dBm), the first device 302 may perform (at 311) subsequent short-range communications with the second device 306 using the first antenna 335a (e.g., the highest WLAN link quality antenna).

At 440, the first device may perform subsequent short-range communications using the determined antenna. For example, referring to FIG. 3B, the first device 302 may perform (at 311) subsequent short-range communications with the second device 306 using the first antenna 335a (e.g., the highest WLAN link quality antenna) or the fourth antenna 335d based on the outcome of 434.

Once the first device determines (at 428, 430, 432, 434, 436, 438, 440) which one of the plurality of antennas to use for subsequent short-range communications with the second device based at least in part on the WLAN link quality information, the method may return to 406.

Referring to FIG. 4D, at 442 if the first device determines (at 408 or 420 in FIG. 4A) that the WLAN link quality information is not available, the first device may determine which one of the plurality of antennas to use for subsequent short-range communications with the second device based at least in part on the WLAN link quality information. For example, referring to FIG. 3B, the first device 302 may determine (at 309) which antenna (e.g., from a plurality of antennas) to use for subsequent short-range communications with the second device 306 based at least in part on the WLAN link quality information.

At 444, the first device may switch between each of the plurality of antennas to determine a short-range communication link quality associated with each of the plurality of antennas. For example, referring to FIG. 3B, assume that the WLAN link quality information is not available at the first device 302. Here, the first device 302 may determine (at 309) which of the plurality of antennas (e.g., 335a, 335b, 335c, 335d) to use for subsequent short-range communications with the second device 306 by switching between each of the plurality of antennas to determine a short-range communication link quality associated with each antenna.

At 446, the first device may determine to use a highest short-range communication link quality antenna for subsequent short-range communications. For example, referring to FIG. 3B, first device 302 may use the highest short-range communication link quality antenna for subsequent short-range communications with the second device 306. For example, assume that the RSSI associated with the first antenna 335a is −35 dBm, the RSSI associated with the second antenna 335b is −46 dBm, the RSSI associated with the third antenna 335c is −57 dBm, and the RSSI associated with the fourth antenna 335d is −70 dBm. Based on the RSSI values of −35 dBm, −46 dBm, −57 dBm, and −70 dBm, the first device 302 may perform subsequent short-range communications with the second device 306 using the first antenna 335a (e.g., highest short-range communications link quality antenna).

At 448, the first device may perform subsequent short-range communications using the determined antenna. For example, referring to FIG. 3B, based on the RSSI values of −35 dBm, −46 dBm, −57 dBm, and −70 dBm, the first device 302 may perform (at 311) subsequent short-range communications with the second device 306 using the first antenna 335a (e.g., highest short-range communications link quality antenna).

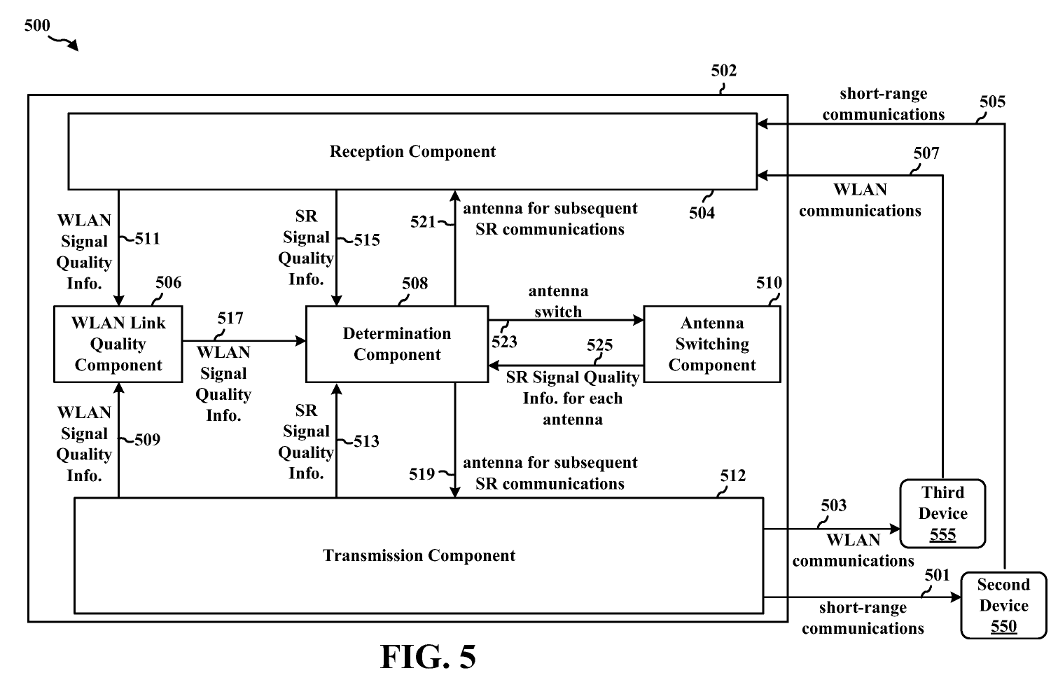

FIG. 5 is a conceptual data flow diagram 500 illustrating the data flow between different means/components in an exemplary apparatus 502. The apparatus may be a first device (e.g., the first device 102, 302, device 200, the apparatus 502/502′) in communication with a second device 550 (e.g., the second device 104, 106, 108, 110, 306) and a third device 555 (e.g., the third device 112, 312). The apparatus may include a reception component 504, a WLAN link quality component 506, a determination component 508, an antenna switching component 510, and a transmission component 512. In certain configurations, the determination component 508 may be part of a short-range communications device (e.g., short-range communications controller 252 in FIG. 2) at the first device. In certain other configurations, the WLAN link quality component 506 may be part of a WLAN communication device (e.g., WLAN controller 250 in FIG. 2) at the first device.

One or more of the reception component 504 and/or the transmission component 512 may be configured to establish a short-range communications link 501, 505 with the second device 550. One or more of the reception component 504 and/or the transmission component 512 may be configured to send a signal 515, 513 associated with short-range communications link quality information to the determination component 508.

One or more of the reception component 504 and/or the transmission component 512 may be configured to establish a WLAN communications link 503, 507 with the third device 555. One or more of the reception component 504 and/or the transmission component 512 may be configured to send a signal 511, 509 associated with WLAN link quality information to the WLAN link quality component 506. In one aspect, the WLAN link quality information may include RSSI, SINR, or EVM. The WLAN link quality component 506 may be configured to send WLAN link quality information 517 to the determination component 508 (e.g., either periodically or when polled by the determination component 508).

The determination component 508 may be configured to determine if a short-range communication link quality associated with the first antenna no longer meets a first threshold criteria within a predetermined time period. The determination component 508 may be further configured to determine if WLAN link quality information is available. The determination component 508 may be further configured to determine the WLAN link quality information when the WLAN link quality information is available. The determination component 508 may be further configured to determine which one of the plurality of antennas to use for subsequent short-range communications with the second device based at least in part on the WLAN link quality information.

In certain aspects, the determination component 508 may be configured to determine which one of the plurality of antennas to use for subsequent short-range communications with the second device based at least in part on the WLAN link quality information by determining, based on the WLAN link quality information, a highest WLAN link quality antenna of the plurality of antennas when it is determined that the short-range communication link quality associated with the first antenna does not meet the first threshold criteria within the predetermined time period. In certain other aspects, the determination component 508 may be configured to determine which one of the plurality of antennas to use for subsequent short-range communications with the second device based at least in part on the WLAN link quality information by determining if a WLAN link quality associated with the highest WLAN link quality antenna meets a second threshold criteria. In certain other aspects, the determination component 508 may be configured to determine which one of the plurality of antennas to use for subsequent short-range communications with the second device based at least in part on the WLAN link quality information by determining to use the first antenna for subsequent short-range communications when it is determined that the WLAN link quality associated with the highest WLAN link quality antenna does not meet the second threshold criteria. In certain other aspects, the determination component 508 may be configured to determine which one of the plurality of antennas to use for subsequent short-range communications with the second device based at least in part on the WLAN link quality information by determining to use the highest WLAN link quality antenna for subsequent short-range communications when it is determined that the WLAN link quality associated with the highest WLAN link quality antenna meets the second threshold criteria.

In certain aspects, the determination component 508 may be configured to determine which one of the plurality of antennas to use for subsequent short-range communications with the second device based at least in part on the WLAN link quality information by determining, based on the WLAN link quality information, the highest WLAN link quality antenna of the plurality of antennas at predetermined intervals when the short-range communication link quality associated with the first antenna meets the first threshold criteria for a duration of the predetermined time period. In certain other aspects, the determination component 508 may be configured to determine which one of the plurality of antennas to use for subsequent short-range communications with the second device based at least in part on the WLAN link quality information by determining if the WLAN link quality associated with the highest WLAN link quality antenna meets a third threshold criteria. In certain other aspects, the determination component 508 may be configured to determine which one of the plurality of antennas to use for subsequent short-range communications with the second device based at least in part on the WLAN link quality information by determining to use the first antenna for subsequent short-range communications when it is determined that the WLAN link quality associated with the highest WLAN link quality antenna does not meet the third threshold criteria. In certain other aspects, the determination component 508 may be configured to determine which one of the plurality of antennas to use for subsequent short-range communications with the second device based at least in part on the WLAN link quality information by determining to use the highest WLAN link quality antenna for subsequent short-range communications when it is determined that the WLAN link quality associated with the highest WLAN link quality antenna meets the third threshold criteria. In one aspect, the first threshold criteria may be lower than the second threshold criteria. In other aspects, the second threshold criteria may be lower than the third threshold criteria.

In certain other aspects, the determination component 508 may be configured to determine that the WLAN link quality information is not available. In certain other aspects, the determination component 508 may be configured to determine which one of the plurality of antennas to use for subsequent short-range communications with the second device based at least in part on the WLAN link quality information by switching between each of the plurality of antennas to determine a short-range communication link quality associated with each of the plurality of antennas when it is determined that that the WLAN link quality is not available. For example, the determination component 508 may be configured to send antenna switch instructions 523 to the antenna switching component 510. The antenna switching component 510 may be configured to switch between each of the plurality of antennas to determine a short-range communication link quality associated with each of the plurality of antennas when it is determined that that the WLAN link quality is not available. The antenna switching component 510 may be configured to send a signal 525 associated with the short-range link quality information for each antenna to the determination component 508. In certain other aspects, the determination component 508 may be configured to determine which one of the plurality of antennas to use for subsequent short-range communications with the second device based at least in part on the WLAN link quality information by determining to use a highest short-range communication link quality antenna for subsequent short-range communications.

The determination component 508 may be configured to send a signal 519, 521 to the transmission component 512 and/or the reception component 504 indicating which antenna to use for subsequent short-range communications with the second device 550.

One or more of the reception component 504 and/or the transmission component 512 may be configured to perform subsequent short-range communications with the second device 550 using the one of the plurality of antennas determined based at least in part on the WLAN link quality information.

The apparatus may include additional components that perform each of the blocks of the algorithm in the aforementioned flowcharts of FIGS. 4A-4D. As such, each block in the aforementioned flowcharts of FIGS. 4A-4D may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof

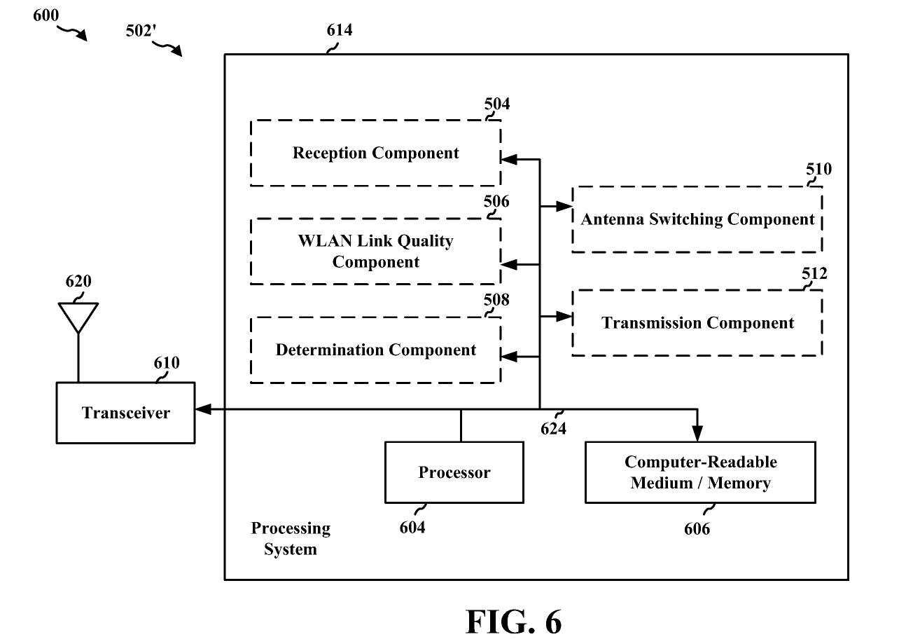

FIG. 6 is a diagram 600 illustrating an example of a hardware implementation for an apparatus 502′ employing a processing system 614. The processing system 614 may be implemented with a bus architecture, represented generally by the bus 624. The bus 624 may include any number of interconnecting buses and bridges depending on the specific application of the processing system 614 and the overall design constraints. The bus 624 links together various circuits including one or more processors and/or hardware components, represented by the processor 604, the components 504, 506, 508, 510, 512, and the computer-readable medium/memory 606. The bus 624 may also link various other circuits such as timing sources, peripherals, voltage regulators, and power management circuits, which are well known in the art, and therefore, will not be described any further.

The processing system 614 may be coupled to a transceiver 610. The transceiver 610 is coupled to one or more antennas 620. The transceiver 610 provides a means for communicating with various other apparatus over a transmission medium. The transceiver 610 receives a signal from the one or more antennas 620, extracts information from the received signal, and provides the extracted information to the processing system 614, specifically the reception component 504. In addition, the transceiver 610 receives information from the processing system 614, specifically the transmission component 512, and based on the received information, generates a signal to be applied to the one or more antennas 620. The processing system 614 includes a processor 604 coupled to a computer-readable medium/memory 606. The processor 604 is responsible for general processing, including the execution of software stored on the computer-readable medium/memory 606. The software, when executed by the processor 604, causes the processing system 614 to perform the various functions described supra for any particular apparatus. The computer-readable medium/memory 606 may also be used for storing data that is manipulated by the processor 604 when executing software. The processing system 614 further includes at least one of the components 504, 506, 508, 510, 512. The components may be software components running in the processor 604, resident/stored in the computer readable medium/memory 606, one or more hardware components coupled to the processor 604, or some combination thereof.

In one configuration, the apparatus 502/502′ for wireless communication may include means for establishing a short-range communications link with a second device. In certain other configurations, the apparatus 502/502′ for wireless communication may include means for sending WLAN link quality information from a WLAN device at the first device to a short-range communications device at the first device. In one aspect, the WLAN link quality information may include at least one of RSSI, SINR, or EVM. In certain other configurations, the apparatus 502/502′ for wireless communication may include means for determining if a short-range communication link quality associated with the first antenna no longer meets a first threshold criteria within a predetermined time period. In certain other configurations, the apparatus 502/502′ for wireless communication may include means for determining if WLAN link quality information is available. In certain other configurations, the apparatus 502/502′ for wireless communication may include means for determining the WLAN link quality information when the WLAN link quality information is available. In certain other configurations, the apparatus 502/502′ for wireless communication may include means for determining which one of the plurality of antennas to use for subsequent short-range communications with the second device based at least in part on the WLAN link quality information. In certain aspects, the means for determining which one of the plurality of antennas to use for subsequent short-range communications with the second device based at least in part on the WLAN link quality information may be configured to determine, based on the WLAN link quality information, a highest WLAN link quality antenna of the plurality of antennas when it is determined that the short-range communication link quality associated with the first antenna does not meet the first threshold criteria within the predetermined time period. In certain aspects, the means for determining which one of the plurality of antennas to use for subsequent short-range communications with the second device based at least in part on the WLAN link quality information may be configured to determine if a WLAN link quality associated with the highest WLAN link quality antenna meets a second threshold criteria. In certain aspects, the means for determining which one of the plurality of antennas to use for subsequent short-range communications with the second device based at least in part on the WLAN link quality information may be configured to determine to use the first antenna for subsequent short-range communications when it is determined that the WLAN link quality associated with the highest WLAN link quality antenna does not meet the second threshold criteria. In certain aspects, the means for determining which one of the plurality of antennas to use for subsequent short-range communications with the second device based at least in part on the WLAN link quality information may be configured to determine to use the highest WLAN link quality antenna for subsequent short-range communications when it is determined that the WLAN link quality associated with the highest WLAN link quality antenna meets the second threshold criteria. In certain aspects, the means for determining which one of the plurality of antennas to use for subsequent short-range communications with the second device based at least in part on the WLAN link quality information may be configured to determine, based on the WLAN link quality information, the highest WLAN link quality antenna of the plurality of antennas at predetermined intervals when the short-range communication link quality associated with the first antenna meets the first threshold criteria for a duration of the predetermined time period. In certain aspects, the means for determining which one of the plurality of antennas to use for subsequent short-range communications with the second device based at least in part on the WLAN link quality information may be configured to determine if the WLAN link quality associated with the highest WLAN link quality antenna meets a third threshold criteria. In certain aspects, the means for determining which one of the plurality of antennas to use for subsequent short-range communications with the second device based at least in part on the WLAN link quality information may be configured to determine to use the first antenna for subsequent short-range communications when it is determined that the WLAN link quality associated with the highest WLAN link quality antenna does not meet the third threshold criteria. In certain aspects, the means for determining which one of the plurality of antennas to use for subsequent short-range communications with the second device based at least in part on the WLAN link quality information may be configured to determine to use the highest WLAN link quality antenna for subsequent short-range communications when it is determined that the WLAN link quality associated with the highest WLAN link quality antenna meets the third threshold criteria. In one aspect, the first threshold criteria may be lower than the second threshold criteria. In other aspects, the second threshold criteria may be lower than the third threshold criteria. In certain other configurations, the apparatus 502/502′ for wireless communication may include means for determining that the WLAN link quality information is not available. In certain aspects, the means for determining which one of the plurality of antennas to use for subsequent short-range communications with the second device based at least in part on the WLAN link quality information may be configured to switch between each of the plurality of antennas to determine a short-range communication link quality associated with each of the plurality of antennas when it is determined that that the WLAN link quality is not available. In certain aspects, the means for determining which one of the plurality of antennas to use for subsequent short-range communications with the second device based at least in part on the WLAN link quality information may be configured to determine to use a highest short-range communication link quality antenna for subsequent short-range communications. In certain other configurations, the apparatus 502/502′ for wireless communication may include means for performing subsequent short-range communications with the second device using the one of the plurality of antennas determined based at least in part on the WLAN link quality information. The aforementioned means may be one or more of the aforementioned processor(s) 202, WLAN controller 250, short-range communications controller 252, and/or radio 230 in FIG. 2, components of the apparatus 502 and/or the processing system 614 of the apparatus 502′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof' include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication for a first wireless device, comprising:
establishing a short-range communication link with a second wireless device using a first antenna of a plurality of antennas at the first wireless device;
determining wireless local area network (WLAN) link quality information associated with each of the plurality of antennas;
determining which one of the plurality of antennas to use for subsequent short-range communications with the second device based at least in part on the WLAN link quality information; and
performing subsequent short-range communications with the second device using the one of the plurality of antennas determined based at least in part on the WLAN link quality information.

2. The method of claim 1, wherein the WLAN link quality information includes at least one of received signal strength indicator (RSSI) information, signal-to-interference-plus-noise ratio (SINR) information, or error vector magnitude (EVM) information.

3. The method of claim 1, further comprising:
sending the WLAN link quality information from a WLAN device at the first device to a short-range communication device at the first device via a coexistence interface.

4. The method of claim 1, further comprising:
determining if a short-range communication link quality associated with the first antenna no longer meets a first threshold criteria within a predetermined time period.

5. The method of claim 4, wherein the determining which one of the plurality of antennas to use for subsequent short-range communications with the second device based at least in part on the WLAN link quality information further comprises:
determining, based on the WLAN link quality information, a highest WLAN link quality antenna of the plurality of antennas when it is determined that the short-range communication link quality associated with the first antenna does not meet the first threshold criteria within the predetermined time period;
determining if a WLAN link quality associated with the highest WLAN link quality antenna meets a second threshold criteria;
determining to use the first antenna for subsequent short-range communications when it is determined that the WLAN link quality associated with the highest WLAN link quality antenna does not meet the second threshold criteria; and
determining to use the highest WLAN link quality antenna for subsequent short-range communications when it is determined that the WLAN link quality associated with the highest WLAN link quality antenna meets the second threshold criteria.

6. The method of claim 5, wherein the determining which one of the plurality of antennas to use for subsequent short-range communications with the second device based at least in part on the WLAN link quality information further comprises:
determining, based on the WLAN link quality information, the highest WLAN link quality antenna of the plurality of antennas at predetermined intervals when the short-range communication link quality associated with the first antenna meets the first threshold criteria for a duration of the predetermined time period;
determining if the WLAN link quality associated with the highest WLAN link quality antenna meets a third threshold criteria;
determining to use the first antenna for subsequent short-range communications when it is determined that the WLAN link quality associated with the highest WLAN link quality antenna does not meet the third threshold criteria; and
determining to use the highest WLAN link quality antenna for subsequent short-range communications when it is determined that the WLAN link quality associated with the highest WLAN link quality antenna meets the third threshold criteria.

7. The method of claim 6, wherein the first threshold criteria is lower than the second threshold criteria.

8. The method of claim 7, wherein the second threshold criteria is lower than the third threshold criteria.

9. The method of claim 1, further comprising:
determining that the WLAN link quality information is not available, wherein the determining which one of the plurality of antennas to use for subsequent short-range communications with the second device based at least in part on the WLAN link quality information comprises:
switching between each of the plurality of antennas to determine a short-range communication link quality associated with each of the plurality of antennas when it is determined that that the WLAN link quality is not available; and
determining to use a highest short-range communication link quality antenna for subsequent short-range communications.

10. An apparatus for wireless communication for a first wireless device, comprising:
means for establishing a short-range communication link with a second wireless device using a first antenna of a plurality of antennas at the first wireless device;
means for determining wireless local area network (WLAN) link quality information associated with each of the plurality of antennas;
means for determining which one of the plurality of antennas to use for subsequent short-range communications with the second device based at least in part on the WLAN link quality information; and
means for performing subsequent short-range communications with the second device using the one of the plurality of antennas determined based at least in part on the WLAN link quality information.

11. The apparatus of claim 10, wherein the WLAN link quality information includes at least one of received signal strength indicator (RSSI) information, signal-to-interference-plus-noise ratio (SINR) information, or error vector magnitude (EVM) information.

12. The apparatus of claim 10, further comprising:
means for sending the WLAN link quality information from a WLAN device at the first device to a short-range communication device at the first device via a coexistence interface.

13. The apparatus of claim 10, further comprising:
means for determining if a short-range communication link quality associated with the first antenna no longer meets a first threshold criteria within a predetermined time period.

14. The apparatus of claim 13, wherein the means for determining which one of the plurality of antennas to use for subsequent short-range communications with the second device based at least in part on the WLAN link quality information is configured to:
determine, based on the WLAN link quality information, a highest WLAN link quality antenna of the plurality of antennas when it is determined that the short-range communication link quality associated with the first antenna does not meet the first threshold criteria within the predetermined time period;
determine if a WLAN link quality associated with the highest WLAN link quality antenna meets a second threshold criteria;
determine to use the first antenna for subsequent short-range communications when it is determined that the WLAN link quality associated with the highest WLAN link quality antenna does not meet the second threshold criteria; and
determine to use the highest WLAN link quality antenna for subsequent short-range communications when it is determined that the WLAN link quality associated with the highest WLAN link quality antenna meets the second threshold criteria.

15. The apparatus of claim 14, wherein the means for determining which one of the plurality of antennas to use for subsequent short-range communications with the second device based at least in part on the WLAN link quality information is configured to:
determine, based on the WLAN link quality information, the highest WLAN link quality antenna of the plurality of antennas at predetermined intervals when the short-range communication link quality associated with the first antenna meets the first threshold criteria for a duration of the predetermined time period;
determine if the WLAN link quality associated with the highest WLAN link quality antenna meets a third threshold criteria;
determine to use the first antenna for subsequent short-range communications when it is determined that the WLAN link quality associated with the highest WLAN link quality antenna does not meet the third threshold criteria; and
determine to use the highest WLAN link quality antenna for subsequent short-range communications when it is determined that the WLAN link quality associated with the highest WLAN link quality antenna meets the third threshold criteria.

16. The apparatus of claim 15, wherein the first threshold criteria is lower than the second threshold criteria.

17. The apparatus of claim 16, wherein the second threshold criteria is lower than the third threshold criteria.

18. The apparatus of claim 10, further comprising:
means for determining that the WLAN link quality information is not available, wherein the means for determining which one of the plurality of antennas to use for subsequent short-range communications with the second device based at least in part on the WLAN link quality information is configured to:
switch between each of the plurality of antennas to determine a short-range communication link quality associated with each of the plurality of antennas when it is determined that that the WLAN link quality is not available; and
determine to use a highest short-range communication link quality antenna for subsequent short-range communications.

19. An apparatus for wireless communication for a first wireless device, comprising:
a memory; and
at least one processor coupled to the memory and configured to:
establish a short-range communication link with a second wireless device using a first antenna of a plurality of antennas at the first wireless device;
determine wireless local area network (WLAN) link quality information associated with each of the plurality of antennas;
determine which one of the plurality of antennas to use for subsequent short-range communications with the second device based at least in part on the WLAN link quality information; and
perform subsequent short-range communications with the second device using the one of the plurality of antennas determined based at least in part on the WLAN link quality information.

20. The apparatus of claim 19, wherein the WLAN link quality information includes at least one of received signal strength indicator (RSSI) information, signal-to-interference-plus-noise ratio (SINR) information, or error vector magnitude (EVM) information.

21. The apparatus of claim 19, wherein the at least one processor is further configured to:
send the WLAN link quality information from a WLAN device at the first device to a short-range communication device at the first device via a coexistence interface.

22. The apparatus of claim 19, wherein the at least one processor is further configured to:
determine if a short-range communication link quality associated with the first antenna no longer meets a first threshold criteria within a predetermined time period.

23. The apparatus of claim 22, wherein the at least one processor is configured to determine which one of the plurality of antennas to use for subsequent short-range communications with the second device based at least in part on the WLAN link quality information by:
determining, based on the WLAN link quality information, a highest WLAN link quality antenna of the plurality of antennas when it is determined that the short-range communication link quality associated with the first antenna does not meet the first threshold criteria within the predetermined time period;
determining if a WLAN link quality associated with the highest WLAN link quality antenna meets a second threshold criteria;
determining to use the first antenna for subsequent short-range communications when it is determined that the WLAN link quality associated with the highest WLAN link quality antenna does not meet the second threshold criteria; and
determining to use the highest WLAN link quality antenna for subsequent short-range communications when it is determined that the WLAN link quality associated with the highest WLAN link quality antenna meets the second threshold criteria.

24. The apparatus of claim 23, wherein the at least one processor is configured to determine which one of the plurality of antennas to use for subsequent short-range communications with the second device based at least in part on the WLAN link quality information by:
determining, based on the WLAN link quality information, the highest WLAN link quality antenna of the plurality of antennas at predetermined intervals when the short-range communication link quality associated with the first antenna meets the first threshold criteria for a duration of the predetermined time period;
determining if the WLAN link quality associated with the highest WLAN link quality antenna meets a third threshold criteria;
determining to use the first antenna for subsequent short-range communications when it is determined that the WLAN link quality associated with the highest WLAN link quality antenna does not meet the third threshold criteria; and
determining to use the highest WLAN link quality antenna for subsequent short-range communications when it is determined that the WLAN link quality associated with the highest WLAN link quality antenna meets the third threshold criteria.

25. The apparatus of claim 24, wherein the first threshold criteria is lower than the second threshold criteria.

26. The apparatus of claim 25, wherein the second threshold criteria is lower than the third threshold criteria.

27. The apparatus of claim 19, wherein the at least one processor is further configured to:
determine that the WLAN link quality information is not available, wherein the at least one processor is configured to determine which one of the plurality of antennas to use for subsequent short-range communications with the second device based at least in part on the WLAN link quality information by:
switching between each of the plurality of antennas to determine a short-range communication link quality associated with each of the plurality of antennas when it is determined that that the WLAN link quality is not available; and
determining to use a highest short-range communication link quality antenna for subsequent short-range communications.

28. A computer-readable medium storing computer executable code for a first wireless device, comprising code to:
establish a short-range communication link with a second wireless device using a first antenna of a plurality of antennas at the first wireless device;
determine wireless local area network (WLAN) link quality information associated with each of the plurality of antennas;
determine which one of the plurality of antennas to use for subsequent short-range communications with the second device based at least in part on the WLAN link quality information; and
perform subsequent short-range communications with the second device using the one of the plurality of antennas determined based at least in part on the WLAN link quality information.

29. The computer-readable medium of claim 28, further comprising code to:
determine if a short-range communication link quality associated with the first antenna no longer meets a first threshold criteria within a predetermined time period, wherein the code to determine which one of the plurality of antennas to use for subsequent short-range communications with the second device based at least in part on the WLAN link quality information is configured to:
determine, based on the WLAN link quality information, a highest WLAN link quality antenna of the plurality of antennas when it is determined that the short-range communication link quality associated with the first antenna does not meet the first threshold criteria within the predetermined time period;
determine if a WLAN link quality associated with the highest WLAN link quality antenna meets a second threshold criteria;
determine to use the first antenna for subsequent short-range communications when it is determined that the WLAN link quality associated with the highest WLAN link quality antenna does not meet the second threshold criteria; and
determine to use the highest WLAN link quality antenna for subsequent short-range communications when it is determined that the WLAN link quality associated with the highest WLAN link quality antenna meets the second threshold criteria.

30. The computer-readable medium of claim 29, wherein the code to determine which one of the plurality of antennas to use for subsequent short-range communications with the second device based at least in part on the WLAN link quality information is configured to:
determine, based on the WLAN link quality information, the highest WLAN link quality antenna of the plurality of antennas at predetermined intervals when the short-range communication link quality associated with the first antenna meets the first threshold criteria for a duration of the predetermined time period;
determine if the WLAN link quality associated with the highest WLAN link quality antenna meets a third threshold criteria;
determine to use the first antenna for subsequent short-range communications when it is determined that the WLAN link quality associated with the highest WLAN link quality antenna does not meet the third threshold criteria; and
determine to use the highest WLAN link quality antenna for subsequent short-range communications when it is determined that the WLAN link quality associated with the highest WLAN link quality antenna meets the third threshold criteria.
